(19) United States
(12) Patent Application Publication
(10) Pub. No.: US 2012/0113069 A1
(43) Pub. Date: May 10, 2012

(54) Display device and method of driving the same

(76) Inventor: Myoung-Ho Kwon, Yongin-City (KR)

(21) Appl. No.: 13/137,336

(22) Filed: Aug. 8, 2011

(30) Foreign Application Priority Data
Nov. 8, 2010 (KR) 10-2010-0110339

(51) Int. Cl. G09G 5/00

(52) U.S. Cl. 345/204

(57) ABSTRACT

A display device and method of driving the same. In present embodiments, dummy pixel columns are included in a panel in stripe pixel arrangement, and stripe driving or delta driving is selectively performed to display data according to the type of data to be displayed.

### CROSS-REFERENCE TO RELATED PATENT APPLICATION

This application claims the benefit of Korean Patent Application No. 10-2010-0110339, filed on Nov. 8, 2010, in the Korean Intellectual Property Office, the disclosure of which is incorporated herein in its entirety by reference.

### BACKGROUND

1. Field

Embodiments relate to a display device and method of driving the same.

2. Description of the Related Art

Currently, display devices are being replaced with portable thin flat panel display devices. In particular, there has recently been interest in flat panel display devices, i.e., organic light emitting display devices and liquid display devices, due to excellent quality characteristics of flat panel display devices.

In flat panel display devices, a lower substrate and an upper substrate are adhered to each other by a sealing member and a plurality of red (R), green (G), and blue (B) pixels are arranged in a matrix form on a panel therebetween.

### SUMMARY

Embodiments are directed to a display device, and a method of driving the same.

According to an embodiment, there is a display device including a mode selection unit for determining a text mode or an image mode by analyzing categories of data to be displayed; and a panel in which a plurality of sub-pixels are arranged in a stripe type arrangement in a plurality of pixel areas defined by a plurality of gate lines and a plurality of source lines, where, among the plurality of source lines, a source line at one of a leftmost side or a rightmost side is regarded as a dummy source line, where a sub-pixel column at one of the leftmost side or the rightmost side of a plurality of sub-pixel columns is connected to the dummy source line as a dummy pixel column, the panel displaying the data in a stripe type arrangement or a delta type arrangement by partially turning off sub-pixels of the sub-pixel columns at the leftmost side and the rightmost side according to a mode selection result.

Two sub-pixel columns of the plurality of sub-pixel columns may be connected to each of the source lines other than the dummy source line. Here, the dummy source line includes sub-pixels, each sub-pixel of the dummy source line may be connected to odd-numbered gate lines, and sub-pixel columns connected to the odd-numbered gate lines and sub-pixel columns connected to even-numbered gate lines may be disposed at left and right sides of the source lines other than the dummy source line.

One sub-pixel column of the plurality of sub-pixel columns may be connected to each of the plurality of source lines.

The panel may display the data in the stripe type arrangement in the text mode and may display the data in the delta type arrangement in the image mode.

The panel may display the data in the stripe type arrangement by displaying black data to the sub-pixel column at the leftmost side or the sub-pixel column at the rightmost side.

The panel may display the data in the delta type arrangement by alternately displaying black data signals to the sub-pixels of the sub-pixel column at the leftmost side and the sub-pixels of the sub-pixel column at the rightmost side.

The display device may further include a timing controller for outputting a gate control signal and a data control signal used to control turning off of sub-pixels according to the mode selection result; a source driver for applying black data to sub-pixels to be turned off according to the data control signal; and a gate driver for outputting a gate signal according to the gate control signal.

According to another embodiment, there is a method of driving a display device, the method including determining a text mode or an image mode by analyzing categories of data to be displayed; outputting a gate control signal and a data control signal according to the mode selection result; and displaying the data in a stripe type arrangement or a delta type arrangement by partially turning off a plurality of sub-pixels of a plurality of sub-pixel columns at a leftmost side and a rightmost side of a panel, in which the sub-pixels are arranged in a stripe type arrangement, according to the gate control signal and the data control signal.

The panel may display the data in the stripe type arrangement in the text mode and may display the data in the delta type arrangement in the image mode

The panel may display the data in the stripe type arrangement by displaying black data to a sub-pixel column at the rightmost side or the leftmost side.

The panel may display the data in the stripe type arrangement in the text mode and may display the data in the delta type arrangement in the image mode

The panel may display the data in the delta type arrangement by alternately displaying black data to the sub-pixels of the sub-pixel column at the leftmost side and the sub-pixels of the sub-pixel column at the rightmost side.

The panel may display the data in the delta type by alternately displaying black data to odd-numbered sub-pixels of the sub-pixel column at the rightmost side and even-numbered sub-pixels of the sub-pixel column at the leftmost side.

The panel may display the data in the delta type by alternately displaying black data to even-numbered sub-pixels of the sub-pixel column at the rightmost side and odd-numbered sub-pixels of the sub-pixel column at the leftmost side.

The determining of a text mode or an image mode may include determining the image mode when text and an image coexist in the data to be displayed.

### BRIEF DESCRIPTION OF THE DRAWINGS

The above and other features will become more apparent by describing in detail exemplary embodiments thereof with reference to the attached drawings in which:

FIG. 1 illustrates a display device according to an embodiment;

FIGS. 2A and 2B illustrate screens displayed by using a stripe type driving method according to an embodiment;

FIGS. 3A and 3B illustrate screens displayed by using a delta type driving method according to an embodiment;

FIG. 4 schematically illustrates a pixel structure of a panel of FIG. 1;

FIGS. 5A through 5D illustrate first stripe driving of the panel of FIG. 4;

FIGS. 6A through 6C illustrate second stripe driving of the panel of FIG. 4;

FIGS. 7A through 7C illustrate first delta driving of the panel of FIG. 4;

FIG. 8 illustrates a pixel structure of another panel of FIG. 1;

FIGS. 9A through 9C illustrate second delta driving of the panel of FIG. 8;

FIG. 10 illustrates a display device according to another embodiment;

FIG. 11 illustrates a pixel structure of a panel of FIG. 10;

FIGS. 12A through 12C illustrate first stripe driving of the panel of FIG. 11;

FIGS. 13A through 13C illustrate second stripe driving of the panel of FIG. 11;

FIGS. 14A through 14C illustrate first delta driving of the panel of FIG. 11;

FIG. 15 illustrates a pixel structure of another panel of FIG. 11;

FIG. 16 illustrates second delta driving of the panel of FIG. 15;

FIG. 17 illustrates a pixel structure of another panel of FIG. 1; and

FIG. 18 illustrates a pixel structure of another panel FIG. 10.

### DETAILED DESCRIPTION

Example embodiments will now be described more fully hereinafter with reference to the accompanying drawings; however, they may be embodied in different forms and should not be construed as limited to the embodiments set forth herein.

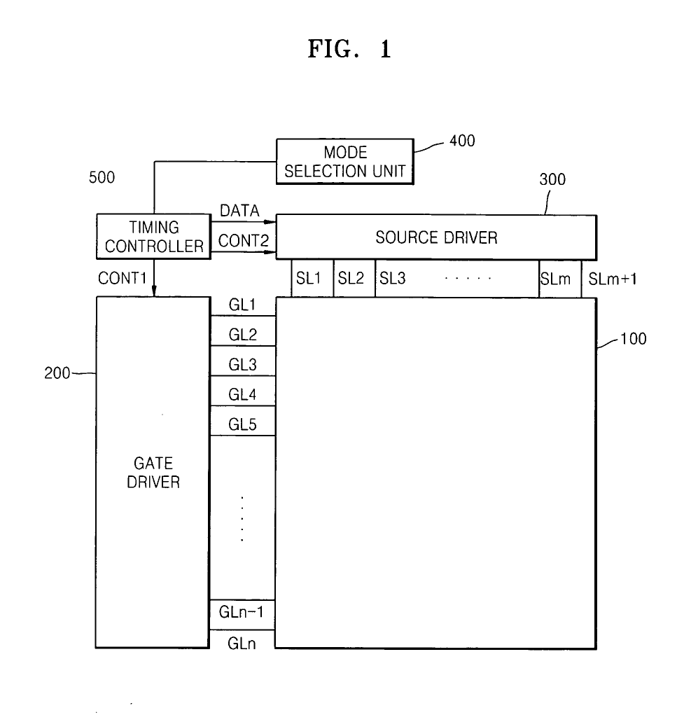

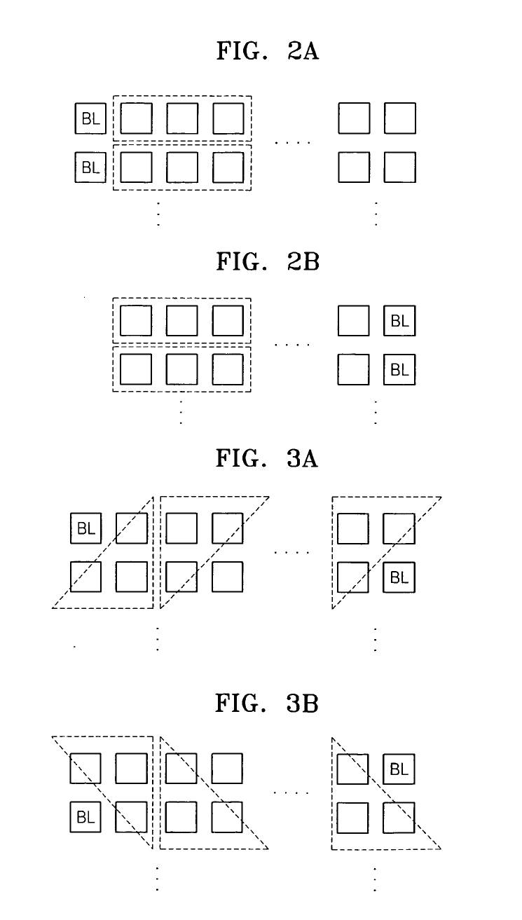

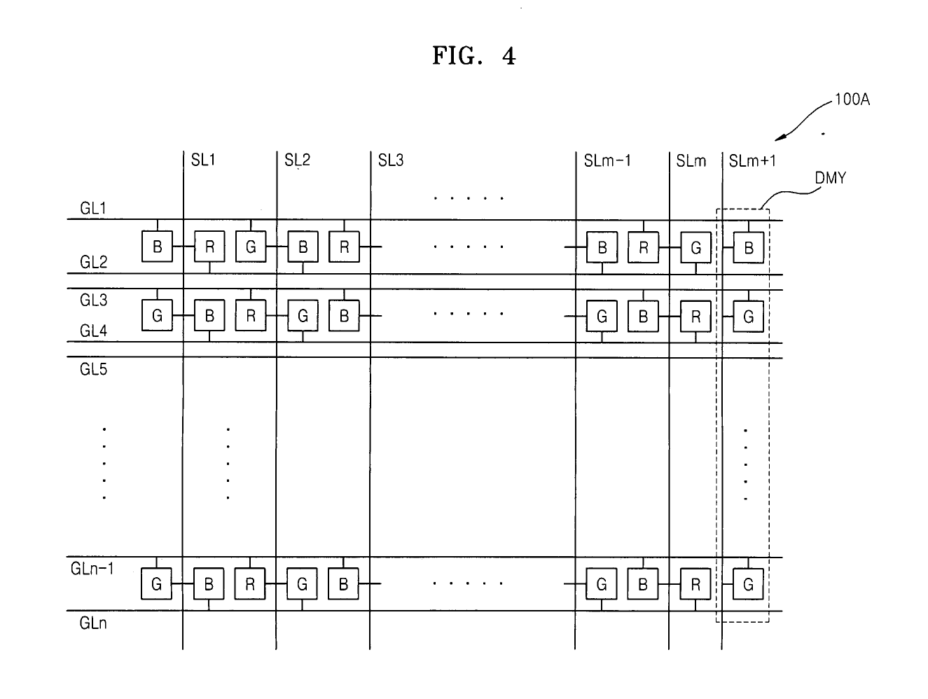

FIG. 1 illustrates a display device according to an embodiment. FIGS. 2A and 2B illustrate screens displayed by using a stripe type driving method according to an embodiment. FIGS. 3A and 3B illustrate screens displayed by using a delta type driving method according to an embodiment.

Referring to FIG. 1, the display device includes a panel 100, a gate driver 200, a source driver 300, a mode selection unit 400, and a timing controller 500.

Gate lines GL1 through GLn spaced apart from each other by a predetermined interval and arranged in rows and source lines SL1 through SLm+1 spaced apart from each other by a predetermined interval and arranged in columns are arranged in the panel 100 in a matrix form.

Sub-pixel areas are defined by the gate lines GL1 through GLn and the source lines SL1 through SLm+1. The source line SLm+1 at the rightmost side is regarded as a dummy source line and a dummy pixel column is connected to the dummy source line SLm+1. Also, sub-pixel columns are connected to the first through m^{th} source lines SL1 through SLm.

The panel 100 has a stripe arrangement in which R, G, and B sub-pixels are repeatedly arranged in a line in each row. In a pixel structure in a delta arrangement, pixels in odd-number rows and even-number rows are arranged in zigzags and thus soft curves may be displayed. However, distortion may occur in lines when displaying straight lines, diagonal lines, or texts. Accordingly, stripe type driving or delta type driving is performed by selectively being switched according to the type of data to be displayed in a pixel structure in a stripe arrangement and thus display quality may be improved. A pixel combination of the panel 100 may vary.

The panel 100 displays data in a stripe type arrangement or a delta type arrangement by partially turning off the sub-pixels of the sub-pixel column at the leftmost side and the dummy pixel column at the rightmost side. When data to be displayed is texts, the panel 100 displays the data in the stripe type arrangement, and when data to be displayed is images, the panel 100 displays the data in the delta type arrangement.

In the stripe type driving (hereinafter, referred to as “stripe driving”), the panel 100 may display data in a first stripe driving mode, in which the sub-pixels of the sub-pixel column at the leftmost side are turned off by applying black data signals thereto, as illustrated in FIG. 2A, or in a second stripe driving mode, in which the sub-pixels of the dummy pixel column at the rightmost side are turned off by applying black data signals thereto, as illustrated in FIG. 2B, regardless of the arrangement order (combination) of the sub-pixels.

In the delta type driving (hereinafter, referred to as “delta driving”), according to the arrangement order (combination) of the sub-pixels, the panel 100 displays data in a delta combination of the sub-pixels by alternately applying black data signals to rows of the sub-pixel column at the leftmost side and the dummy pixel column at the rightmost side, as illustrated in FIGS. 3A and 3B. As illustrated in FIG. 3A, the panel 100 displays data in a first delta driving mode, in which the odd-numbered sub-pixels of the sub-pixel column at the leftmost side and the even-numbered sub-pixels of the dummy pixel column at the rightmost side are turned off by applying black data signals thereto. As illustrated in FIG. 3B, the panel 100 displays data in a second delta driving mode, in which the even-numbered sub-pixels of the sub-pixel column at the leftmost side and the odd-numbered sub-pixels of the dummy pixel column at the rightmost side are turned off by applying black data signals thereto.

For example, when sub-pixel rows are alternately repeated such as RGB/BRG, RBG/GRB, GRB/BGR, GBR/RGB, BRG/GBR, or BGR/RBG in the panel 100, the panel 100 may be driven by the first and second stripe driving modes and the first delta driving mode. As another example, when sub-pixel rows are alternately repeated such as RGB/GBR, RBG/BGR, GRB/RBG, GBR/BRG, BRG/RGB, or BGR/GRB, the panel 100 may be driven by the first and second stripe driving modes and the second delta driving mode.

The gate driver 200 may generate gate signals having a combination of a gate-on-voltage at an active level and a gate-off-voltage at a non-active level and sequentially supplies the gate signals to the panel 100 through the plurality of gate lines GL1 through GLn.

The source driver 300 may sequentially supply data signals to the panel 100 through the plurality of source lines SL1 through SLm+1. The source driver 300 converts input gray scale image data input from the timing controller 500 into a voltage or current form data signal. Also, the source driver 300 applies black data signals to the sub-pixels that are to be turned off based on a data control signal input from the timing controller 500.

The mode selection unit 400 determines a text mode or an image mode by analyzing a category of a menu selected by a user. The mode selection unit 400 may select a mode based on relative priority of text and image of data to be displayed. In the text mode, texts such as short message service (SMS) messages are mainly displayed. In the image mode, images such as photos, moving images, or still images are mainly displayed. When images and texts coexist, for example, when subtitles are displayed while reproducing a movie or when text messages are processed while capturing photographs, the image mode may be determined.

When the text mode is selected, the panel 100 is driven by the stripe driving, and when the image mode is selected, the panel 100 is driven by the delta driving.

The timing controller 500 generates a gate control signal CONT1 and a data control signal CONT2 according to a mode selection result of the mode selection unit 400 and transmits the gate control signal CONT1 and the data control signal CONT2 to the gate driver 200 and the source driver 300, respectively. The timing controller 500 sequentially applies the gate-on-voltage to the gate lines GL1 through GLn and applies the data signals to the sub-pixels so that the panel 100 displays an image of one frame.

FIG. 4 schematically illustrates a pixel structure of a panel of FIG. 1.

Referring to FIG. 4, a panel 100A includes a plurality of red R, green G, and blue B sub-pixels arranged in a stripe type arrangement in an area where the source lines SL1 through SLm+1 and the gate lines GL1 through GLn cross each other.

Two sub-pixels from among the R, G, and B sub-pixels in each row are connected to left and right sides of each of the first through m^{th} source lines SL1 through SLm. The sub-pixels at the left sides of the first through m^{th} source lines SL1 through SLm are connected to the odd-numbered gate lines and the sub-pixels at the right side of the first through m^{th} source lines SL1 through SLm are connected to the even-numbered gate lines. The m+1^{th} source line SLm+1 at the rightmost side is a dummy source line, and one of the R, G, and B sub-pixels is connected as a dummy pixel to the dummy source line SLm+1 in each row. Each dummy pixel is connected to the odd-numbered gate lines.

The gate-on-signals from the first gate line GL1 to the n^{th} gate line GLn are sequentially applied to the panel 100A and switching devices of the sub-pixels are turned on by the gate-on-signals. Thus, the data signals from the first source line SL1 to the dummy source line SLm+1 are sequentially applied to the sub-pixels.

Hereinafter, driving of the panel 100A, in which rows where B, R, and G sub-pixels are repeated and rows where G, B, and R sub-pixels are repeated are alternately arranged and in which B and G subpixels are alternately arranged in the dummy pixel column, will be described. A pixel combination is not limited thereto.

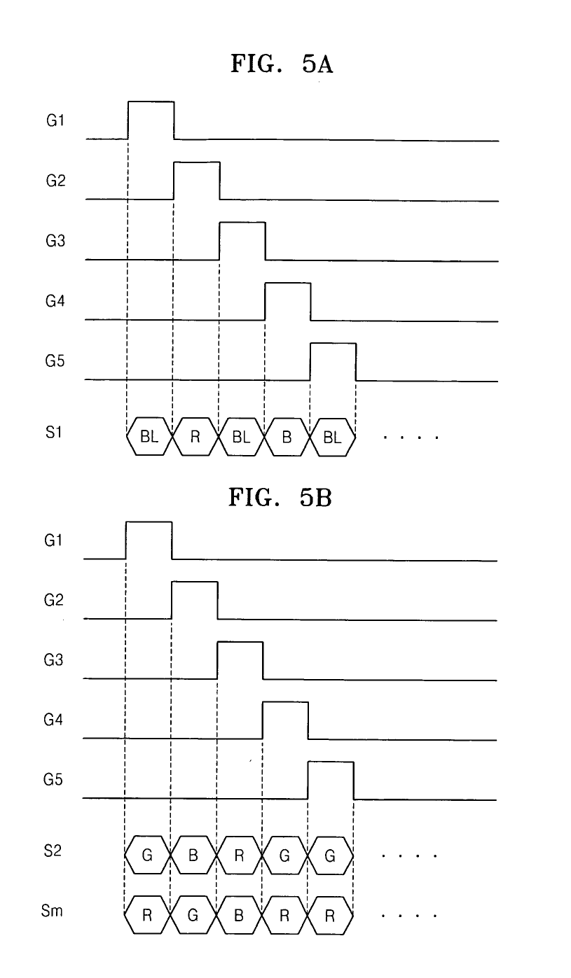

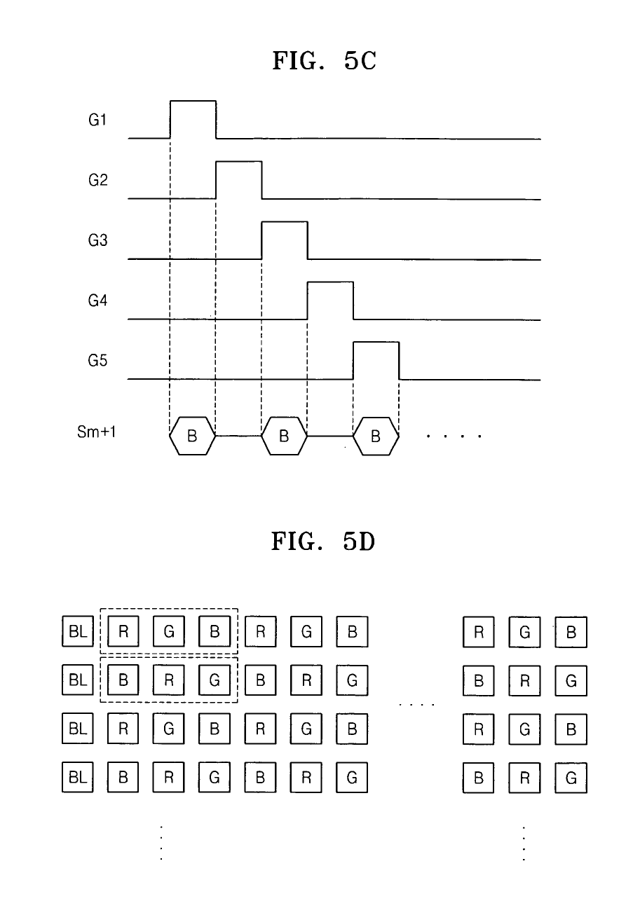

FIGS. 5A through 5D illustrate first stripe driving of the panel 100A of FIG. 4.

In the first stripe driving, black data signals BL are applied to the sub-pixels of the sub-pixel column at the leftmost side when data is to be displayed in the text mode.

The gate-on-signals from the gate driver 200 are sequentially applied to the first gate line GL1 to the n^{th} gate line GLn. In FIGS. 5A through 5C, first through fifth gate-on-signals G1 through G5 are exemplarily illustrated and are sequentially applied to the first through fifth gate lines GL1 through GL5.

Referring to FIG. 5A, a first data signal S1 is applied from the source driver 300 to the first source line SL1. The source driver 300 applies black data signals BL when the odd-numbered gate-on-signals G1, G3, G5, . . . are applied to the odd-numbered gate lines GL1, GL3, GL5, . . . and applies pixel data signals when the even-numbered gate-on-signals G2, G4, . . . are applied to the even-numbered gate lines GL2, GL4, . . . .

Accordingly, the source driver 300 sequentially outputs black BL, red R, black BL, and blue B data signals to the first source line SL1 as the first data signal S1.

Referring to FIG. 5B, second through m^{th} data signals S2 through Sm are applied to the second through m^{th} source lines SL2 through SLm from the source driver 300. The source driver 300 applies pixel data signals when the odd-numbered gate-on-signals G1, G3, G5, . . . and the even-numbered gate-on-signals G2, G4, . . . are respectively applied to the odd-numbered gate lines GL1, GL3, GL5, . . . and the even-numbered gate lines GL2, GL4, . . . .

Accordingly, the source driver 300 sequentially outputs green G, blue B, red R, and green G data signals to the second source line SL2 as the second data signal S2, and sequentially outputs red R, green G, blue B, and red R data signals to the m^{th} source line SLm as the mth data signal Sm.

Similarly, the third through m−1^{th} data signals S3 through Sm−1 are output to the third through m−1^{th} source lines SL3 through SLm−1.

Referring to FIG. 5C, a dummy data signal Sm+1 is applied from the source driver 300 to the dummy source line SLm+1. The source driver 300 applies pixel data signals when the odd-numbered gate-on-signals G1, G3, G5, . . . are applied to the odd-numbered gate lines GL1, GL3, GL5, . . . and applies blank data signals when the even-numbered gate-on-signals G2, G4, . . . are applied to the even-numbered gate lines GL2, GL4, . . . .

Accordingly, the source driver 300 sequentially outputs blue B and green G data signals to the dummy source line SLm+1 as the dummy data signal Sm+1 with blank spaces interposed between the blue B and green G data signals.

Referring to FIG. 5D, the sub-pixels of the sub-pixel column at the leftmost side are turned off by the data signals of FIGS. 5A through 5C in the panel 100A, and R, G, and B sub-pixel rows and B, R, and G sub-pixel rows are alternately arranged so that data is displayed by the first stripe driving.

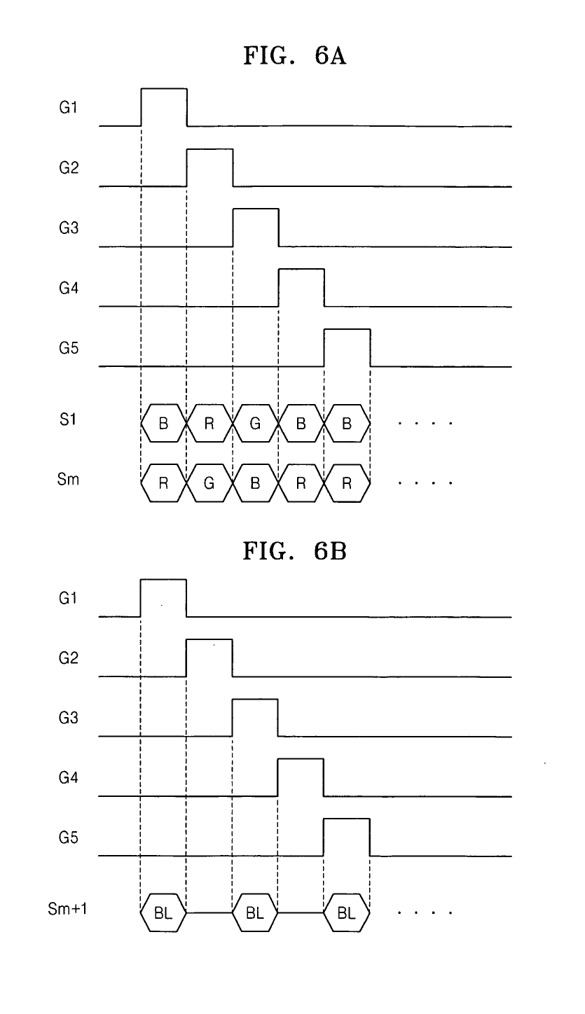

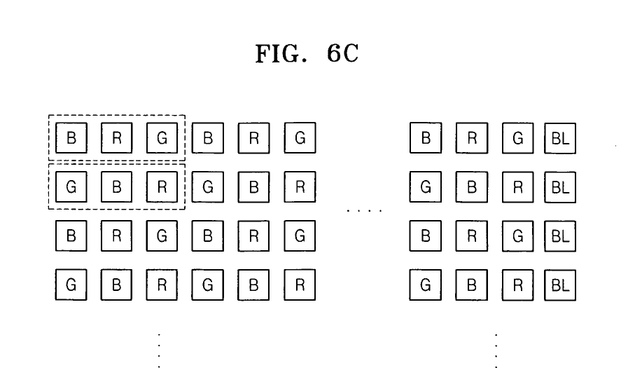

FIGS. 6A through 6C illustrate second stripe driving of the panel 100A of FIG. 4.

In the second stripe driving, black data signals BL are applied to the sub-pixels of the dummy pixel column at the rightmost side when data is to be displayed in the text mode.

The gate-on-signals from the gate driver 200 are sequentially applied to the first gate line GL1 to the n^{th} gate line GLn. In FIGS. 6A and 6B, the first through fifth gate-on-signals G1 through G5 are exemplarily illustrated and are sequentially applied to the first through fifth gate lines GL1 through GL5.

Referring to FIG. 6A, the first through m^{th} data signals S1 through Sm are applied from the source driver 300 to the first through m^{th} source lines SL1 through SLm. The source driver 300 applies pixel data signals when the odd-numbered gate-on-signals G1, G3, G5, . . . and the even-numbered gate-on-signals G2, G4, . . . are respectively applied to the odd-numbered gate lines GL1, GL3, GL5, . . . and the even-numbered gate lines GL2, GL4, . . . .

Accordingly, the source driver 300 sequentially outputs blue B, red R, green G, and blue B data signals to the first source line SL1 as the first data signal S1, and sequentially outputs red R, green G, blue B, and red R data signals to the m^{th} source line SLm as the m^{th} data signal Sm.

Similarly, the second through m−1^{th} data signals S2 through Sm−1 are output to the second through m−1^{th} source lines SL2 through SLm−1.

Referring to FIG. 6B, the dummy data signal Sm+1 is applied from the source driver 300 to the dummy source line SLm+1. The source driver 300 applies black data signals BL when the odd-numbered gate-on-signals G1, G3, G5, . . . are applied to the odd-numbered gate lines GL1, GL3, GL5, . . . and applies blank data signals when the even-numbered gate-on-signals G2, G4, . . . are applied to the even-numbered gate lines GL2, GL4, . . . .

Accordingly, the source driver 300 sequentially outputs black data signals BL to the dummy source line SLm+1 as the dummy data signal Sm+1 with blank spaces interposed between the black data signals BL.

Referring to FIG. 6C, the sub-pixels of the dummy pixel column at the rightmost side are turned off by the data signals of FIGS. 6A and 6B in the panel 100A, and B, R, and G sub-pixel rows and G, B, and R sub-pixel rows are alternately arranged so that data is displayed by the second stripe driving.

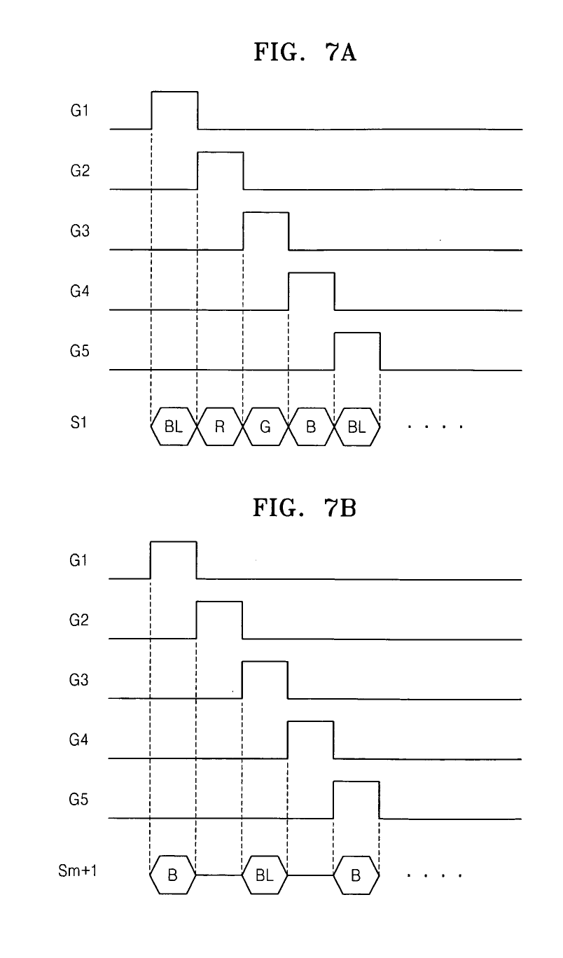

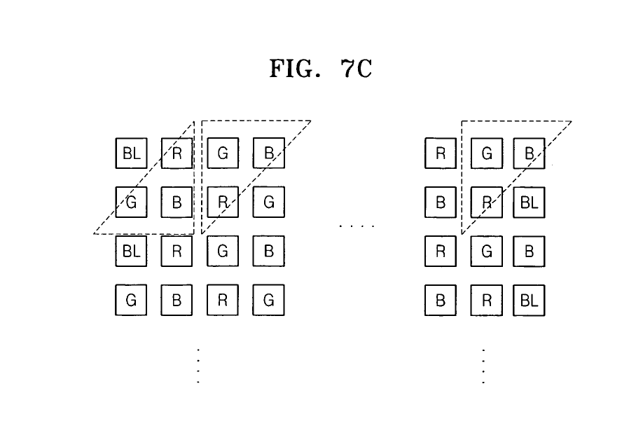

FIGS. 7A through 7C illustrate first delta driving of the panel 100A of FIG. 4.

In the first delta driving, when data is to be displayed in the image mode, black data signals BL are applied to the sub-pixels of the sub-pixel column at the leftmost side connected to every other gate line starting from the first gate line G1 from among the odd-numbered gate lines, that is, the first, fifth, ninth gate lines GL1, GL5, GL9, . . . , and black data signals BL are applied to the dummy pixels of the dummy pixel column at the rightmost side connected to every other gate line starting from the third gate line from among the odd-numbered gate lines, that is, the third, seventh, eleventh gate lines GL3, GL7, GL11, . . . .

The gate-on-signals from the gate driver 200 are sequentially applied to the first gate line GL1 to the n^{th} gate line GLn. In FIGS. 7A and 7B, the first through fifth gate-on-signals G1 through G5 are exemplarily illustrated and are sequentially applied to the first through fifth gate lines GL1 through GL5.

Referring to FIG. 7A, the first data signal S1 is applied from the source driver 300 to the first source line SL1. The source driver 300 applies black data signals BL when the gate-on-signals G1, G5, G9, . . . are applied to the odd-numbered gate lines GL1, GL5, GL9, . . . , and applies pixel data signals when the gate-on-signals G3, G7, G11, . . . are applied to the odd-numbered gate lines GL3, GL7, GL11 . . . . Also, the source driver 300 applies pixel data signals when the even-numbered gate-on-signals G2, G4, . . . are applied to the even-numbered gate lines GL2, GL4, . . . .

Accordingly, the source driver 300 sequentially outputs black BL, red R, green G, and blue B data signals to the first source line SL1 as the first data signal S1.

Although not illustrated, the source driver 300 applies pixel data signals to the second through m^{th} source lines SL2 through SLm as the second through mth data signals S2 through Sm when the odd-numbered gate-on-signals G1, G3, G5, . . . and the even-numbered gate-on-signals G2, G4, . . . are applied to the odd-numbered gate lines GL1, GL3, GL5, . . . and the even-numbered gate lines GL2, GL4, . . . , respectively.

Referring to FIG. 7B, the dummy data signal Sm+1 is applied to the dummy source line SLm+1 from the source driver 300. The source driver 300 applies black BL data signals when the odd-numbered gate-on-signals G3, G7, G11, . . . are applied to the odd-numbered gate lines GL3, GL7, GL11, . . . , and applies pixel data signals when the gate-on-signals G1, G5, G9, . . . are applied to the odd-numbered gate lines GL1, GL5, GL9, . . . . Also, the source driver 300 applies blank data signals when the even-numbered gate-on-signals G2, G4, . . . are applied to the even-numbered gate lines GL2, GL4, . . . .

Accordingly, the source driver 300 sequentially outputs blue B and black BL data signals to the dummy source line SLm+1 as the dummy data signal Sm+1 with blank spaces interposed between the blue B and black BL data signals.

Referring to FIG. 7C, the odd-numbered sub-pixels at the leftmost side and the even-numbered sub-pixels at the rightmost side are turned off by the data signals of FIGS. 7A and 7B in the panel 100A, and data is displayed by the first delta driving through a combination of R, G, and B sub-pixels in two rows.

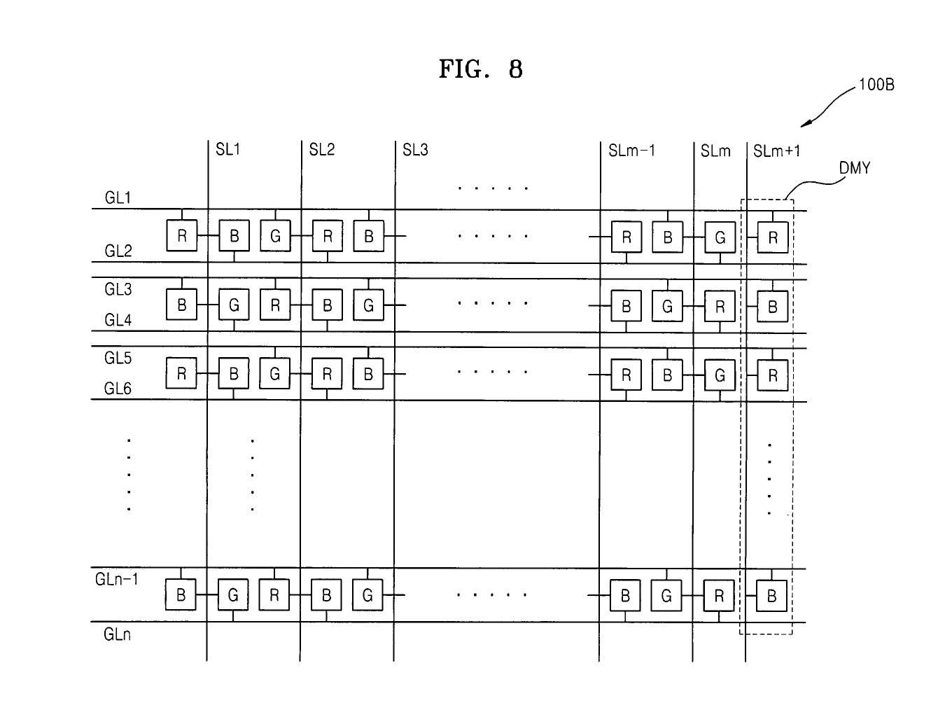

FIG. 8 illustrates a pixel structure of another panel of FIG. 1.

In a panel 100B of FIG. 8, rows where R, B, and G sub-pixels are repeated and rows where B, G, and R sub-pixels are repeated are arranged alternately arranged. However, although a sub-pixel arrangement of the panel 100B of FIG. 8 is different from that of the panel 100A of FIG. 4, other elements are the same as those of the panel 100A of FIG. 4.

The first and second stripe driving of the panel 100B of FIG. 8 are the same as those of FIGS. 5A through 6C and thus detailed description thereof is omitted.

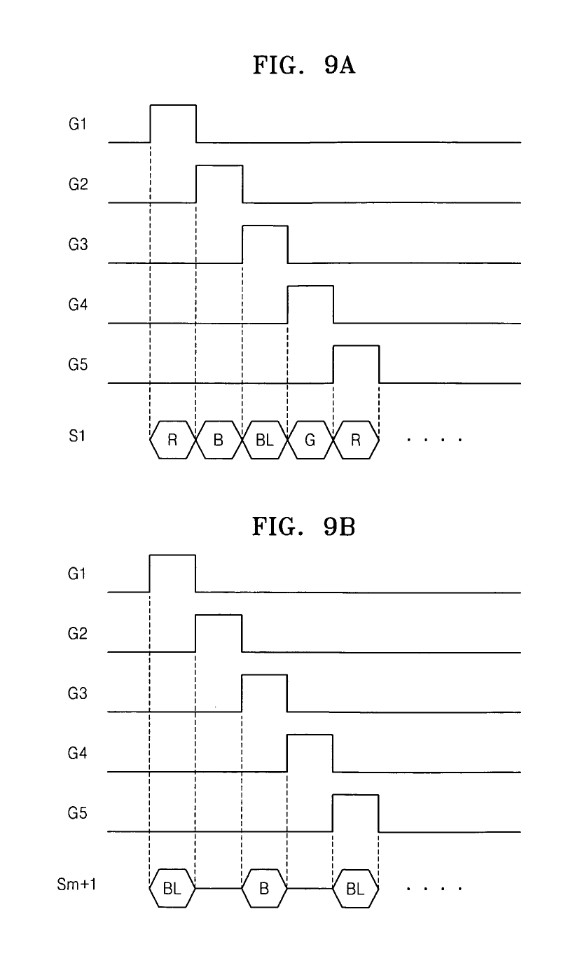

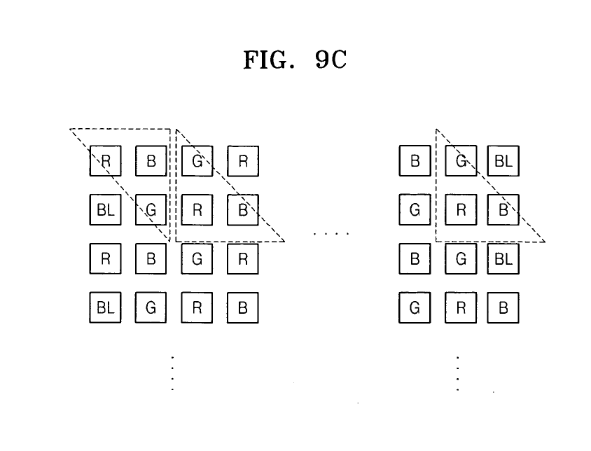

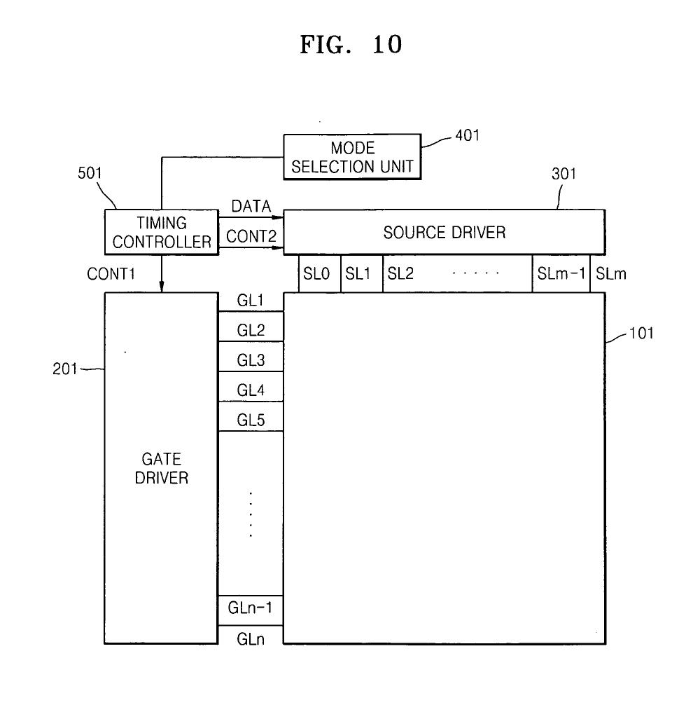

FIGS. 9A through 9C illustrate second delta driving of the panel 100B of FIG. 8.

In the second delta driving, when data is to be displayed in the image mode, black data signals BL are applied to the sub-pixels of the sub-pixel column at the leftmost side connected to every other gate line starting from the third gate line from among the odd-numbered gate lines, that is, the third, seventh, eleventh gate lines GL3, GL7, GL11, . . . , and black data signals BL are applied to the dummy pixels of the dummy pixel column at the rightmost side connected to every other gate line starting from the first gate line from among the odd-numbered gate lines, that is, the first, fifth, ninth gate lines GL1, GL5, GL9, . . . .

The gate-on-signals from the gate driver 200 are sequentially applied to the first gate line GL1 to the n^{th} gate line GLn. In FIGS. 9A and 9B, the first through fifth gate-on-signals G1 through G5 are exemplarily illustrated and are sequentially applied to the first through fifth gate lines GL1 through GL5.

Referring to FIG. 9A, the first data signal S1 is applied from the source driver 300 to the first source line SL1. The source driver 300 applies pixel data signals when the gate-on-signals G1, G5, G9, . . . are applied to the odd-numbered gate lines GL1, GL5, GL9, . . . and applies black data signals BL when the gate-on-signals G3, G7, G11, . . . are applied to the odd-numbered gate lines GL3, GL7, GL11 . . . . Also, the source driver 300 applies pixel data signals when the even-numbered gate-on-signals G2, G4, . . . are applied to the even-numbered gate lines GL2, GL4, . . . .

Accordingly, the source driver 300 sequentially outputs red R, blue B, black BL, and green G data signals to the first source line SL as the first data signal S1.

Although not illustrated, the source driver 300 applies pixel data signals to the second through m^{th} source lines SL2 through SLm as the second through mth data signals S2 through Sm when the odd-numbered gate-on-signals G1, G3, and G5, . . . and the even-numbered gate-on-signals G2, G4, . . . are applied to the odd-numbered gate lines GL1, GL3, and GL5, . . . and the even-numbered gate lines GL2, GL4, . . . , respectively.

Referring to FIG. 9B, the dummy data signal Sm+1 is applied to the dummy source line SLm+1 from the source driver 300. The source driver 300 applies black BL data signals when the gate-on-signals G1, G5, G9, . . . are applied to the odd-numbered gate lines GL1, GL5, GL9, . . . , and applies pixel data signals when the gate-on-signals G3, G7, G11, . . . are applied to the odd-numbered gate lines GL3, GL7, GL11, . . . . Also, the source driver 300 applies blank data signals when the even-numbered gate-on-signals G2, G4, . . . are applied to the even-numbered gate lines GL2, GL4, . . . .

Accordingly, the source driver 300 sequentially outputs black BL and blue B data signals to the dummy source line SLm+1 as the dummy data signal Sm+1 with blank spaces interposed between the black BL and blue B data signals.

Referring to FIG. 9C, the even-numbered sub-pixels at the leftmost side and the odd-numbered sub-pixels at the rightmost side are turned off by the data signals of FIGS. 9A and 9B in the panel 100B, and data is displayed by the second delta driving through a combination of R, G, and B sub-pixels in two rows.

FIG. 10 illustrates a display device according to another embodiment.

Referring to FIG. 10, the display device includes a panel 101, a gate driver 201, a source driver 301, a mode selection unit 401, and a timing controller 501.

In the panel 101, sub-pixel areas are defined by gate lines GL1 through GLn and source lines SL0 through SLm. The source line SL0 at the leftmost side is regarded as a dummy source line and a dummy pixel column is connected to the dummy source line SL0. Also, sub-pixel columns are connected to the first through m^{th} source line SL1 through SLm. Though the panel 101 is different from the panel 100 of FIG. 1 in that the dummy source line is at the leftmost side, other elements are the same as those of FIG. 1. Thus, detailed description thereof is omitted.

The mode selection unit 401 determines a text mode or an image mode by analyzing a category of a menu selected by a user. When the text mode is selected, the panel 101 is driven by stripe driving and when the image mode is selected, the panel 101 is driven by delta driving.

In the stripe driving, the panel 101 may display data in a first stripe driving mode, in which the sub-pixels of the dummy pixel column at the leftmost side are turned off by applying black data signals thereto, as illustrated in FIG. 2A, or in a second stripe driving mode, in which the sub-pixels of the sub-pixel column at the rightmost side are turned off by applying black data signals thereto, as illustrated in FIG. 2B, regardless of the arrangement order (combination) of the sub-pixels.

In the delta driving, according to the arrangement order (combination) of the sub-pixels, the panel 101 displays data in a delta combination of the sub-pixels by alternately applying black data signals to rows of the sub-pixel column at the rightmost side and the dummy pixel column at the leftmost side, as illustrated in FIGS. 3A and 3B. As illustrated in FIG. 3A, the panel 101 displays data in a first delta driving mode, in which the odd-numbered sub-pixels of the dummy pixel column at the leftmost side and the even-numbered sub-pixels of the sub-pixel column at the rightmost side are turned off by applying black data signals thereto. As illustrated in FIG. 3B, the panel 101 displays data in a second delta driving mode, in which the even-numbered sub-pixels of the dummy pixel column at the leftmost side and the odd-numbered sub-pixels of the sub-pixel column at the rightmost side are turned off by applying black data signals thereto.

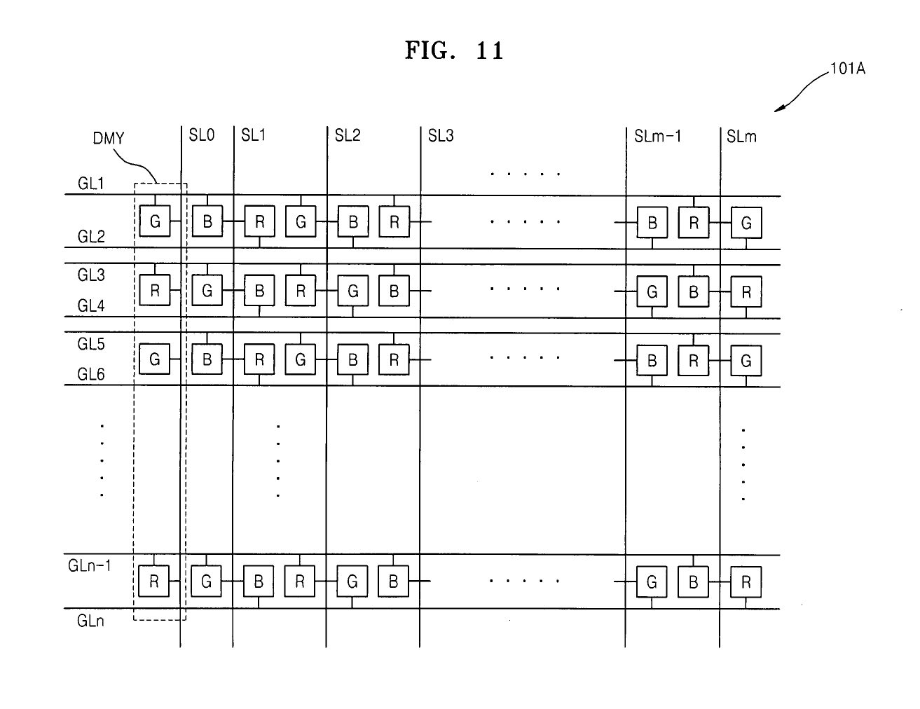

FIG. 11 illustrates a pixel structure of a panel of FIG. 10.

Referring to FIG. 11, a panel 101A includes a plurality of red R, green G, and blue B sub-pixels arranged in a stripe type arrangement in an area where the source lines SL0 through SLm and the gate lines GL1 through GLn cross each other.

Two sub-pixels from among the R, G, and B sub-pixels in each row are connected to left and right sides of each of the first through m^{th} source lines SL1 through SLm. The sub-pixels at the left side of the first through m^{th} source lines SL1 through SLm are connected to the odd-numbered gate lines and the sub-pixels at the right sides of the first through m^{th} source lines SL1 through SLm are connected to the even-numbered gate lines. One of the R, G, and B sub-pixels is connected to the dummy source line SL0 at the leftmost side in each row. Each dummy pixel is connected to the odd-numbered gate lines. Gate-on-signals from the first gate line GL1 to the n^{th} gate line GLn are sequentially applied to the panel 101A and switching devices of the sub-pixels are turned on by the gate-on-signals. Thus, data signals from the dummy source line SL0 to the m^{th} source line SLm are sequentially applied to the sub-pixels.

Hereinafter, driving of the panel 101A, in which rows where B, R, and G sub-pixels are repeated and rows where G, B, and R sub-pixels are repeated are alternately arranged and in which G and R dummy pixels are alternately arranged in the dummy pixel column, will be described.

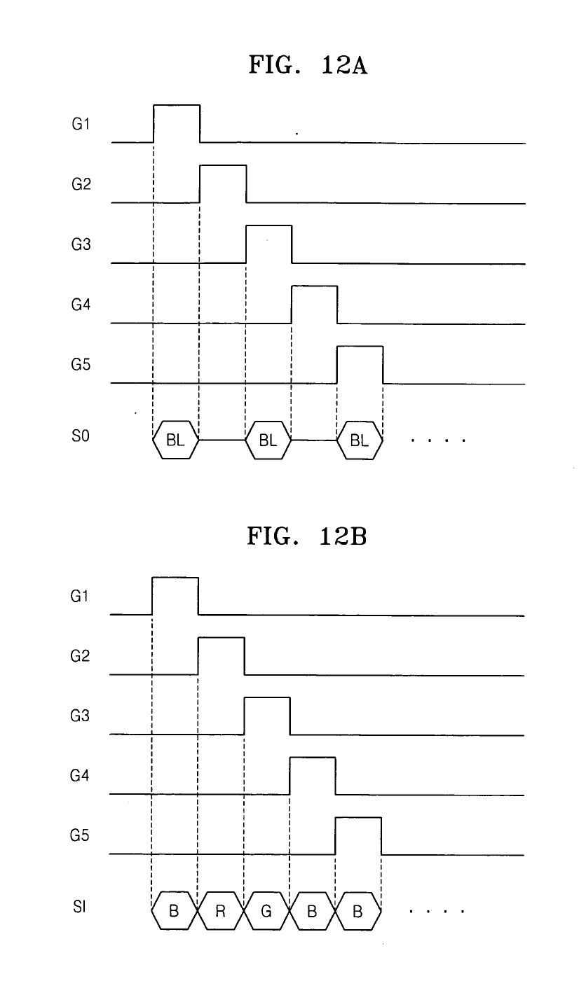

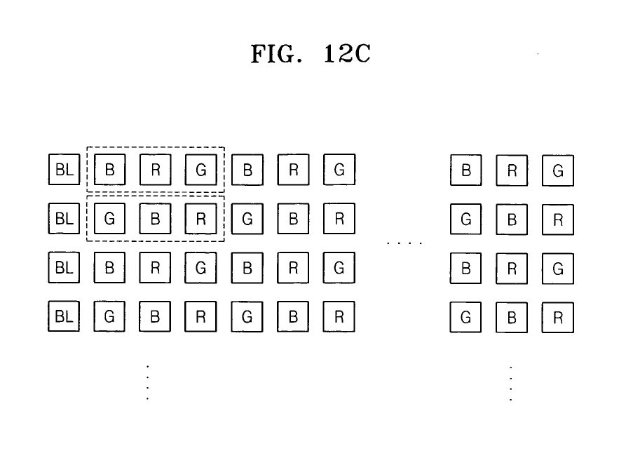

FIGS. 12A through 12C illustrate first stripe driving of the panel 101A of FIG. 11.

In the first stripe driving, black data signals BL are applied to the sub-pixels of the dummy pixel column at the leftmost side when data is to be displayed in the text mode.

The gate-on-signals from the gate driver 201 are sequentially applied to the first gate line GL1 to the n^{th} gate line GLn. In FIGS. 12A and 12B, the first through fifth gate-on-signals G1 through G5 are exemplarily illustrated and are sequentially applied to the first through fifth gate lines GL1 through GL5.

Referring to FIG. 12A, a dummy data signal S0 is applied from the source driver 301 to the dummy source line SL0. The source driver 301 applies black data signals BL when odd-numbered gate-on-signals G1, G3, G5, . . . are applied to the odd-numbered gate lines GL1, GL3, GL5, . . . and applies blank data signals when the even-numbered gate-on-signals G2, G4, . . . are applied to the even-numbered gate lines GL2, GL4, . . . .

Accordingly, the source driver 301 sequentially outputs black BL data signals to the dummy source line SL0 as the dummy data signal S0 with blank spaces interposed between the black data signals BL.

Referring to FIG. 12B, first through m^{th} data signals S1 through Sm are applied to the first through m^{th} source lines SL1 through SLm from the source driver 301. The source driver 301 applies pixel data signals to the first through m^{th} source lines SL1 through SLm when the odd-numbered gate-on-signals G1, G3, G5, . . . and the even-numbered gate-on-signals G2, G4, . . . are respectively applied to the odd-numbered gate lines GL1, GL3, GL5, . . . and the even-numbered gate lines GL2, GL4, . . . .

Accordingly, the source driver 301 sequentially outputs blue B, red R, green G, and blue B data signals to the first source line SL1 as the first data signal S1.

Similarly, the source driver 301 outputs the second through m^{th} data signals S2 through Sm to the second through m^{th} source lines SL2 through SLm.

Referring to FIG. 12C, the panel 101A displays data by stripe driving B, R, G sub-pixel rows and G, B, and R sub-pixel rows by the data signals of FIGS. 12A and 12B.

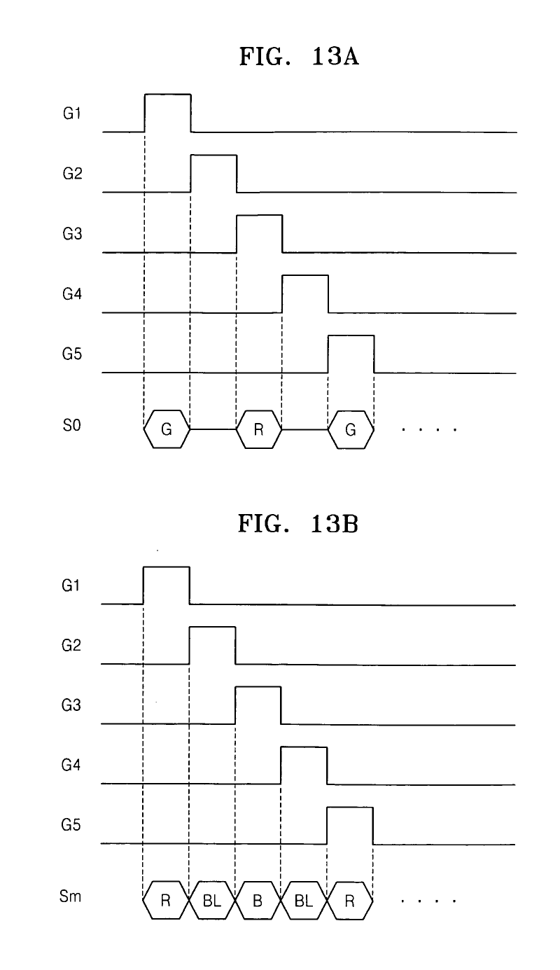

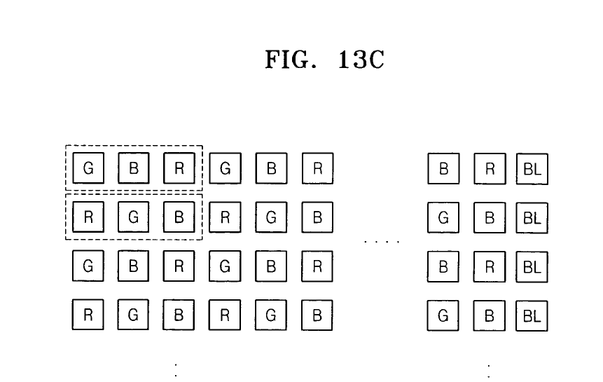

FIGS. 13A through 13C illustrate second stripe driving of the panel 101A of FIG. 11.

In the second stripe driving, black data signals BL are applied to the sub-pixels of the sub-pixel column at the rightmost side when data is to be displayed is in the text mode.

The gate-on-signals from the gate driver 201 are sequentially applied to the first gate line GL1 to the n^{th} gate line GLn. In FIGS. 13A and 13B, the first through fifth gate-on-signals G1 through G5 are exemplarily illustrated and are sequentially applied to the first through fifth gate lines GL1 through GL5.

Referring to FIG. 13A, the dummy data signal S0 is applied from the source driver 301 to the dummy source line SL0. The source driver 301 applies pixel data signals when the odd-numbered gate-on-signals G1, G3, G5, . . . are applied to the odd-numbered gate lines GL1, GL3, GL5, and applies blank data signals when the even-numbered gate-on-signals G2, G4, . . . are applied to the even-numbered gate lines GL2, GL4, . . . .

Accordingly, the source driver 301 sequentially outputs green G and red R data signals to the dummy source line SL0 as the dummy data signal S0 with blank spaces interposed between the green G and red R data signals.

Although not illustrated, the source driver 301 applies pixel data signals to the first through m−1^{th} source lines SL1 through SLm−1 as the first through m−1^{th} data signals S1 through Sm−1 when the odd-numbered gate-on-signals G1, G3, G5, . . . and the even-numbered gate-on-signals G2, G4, . . . are applied to the odd-numbered gate lines GL1, GL3, GL5, . . . and the even-numbered gate lines GL2, GL4, . . . , respectively.

Referring to FIG. 13B, the m^{th} data signal Sm is applied to the m^{th} source line SLm from the source driver 301. The source driver 301 applies pixel data signals when the odd-numbered gate-on-signals G1, G3, G5, . . . are applied to the odd-numbered gate lines GL1, GL3, GL5, . . . , and applies black data signals BL when the even-numbered gate-on-signals G2, G4, . . . are applied to the even-numbered gate lines GL2, GL4, . . . .

Accordingly, the source driver 301 sequentially outputs red R, black BL, blue B, and black BL data signals to the m^{th} source line SLm as the m^{th} data signal Sm.

Referring to FIG. 13C, the panel 101A displays data by stripe driving G, B, R sub-pixel rows and R, G, and B sub-pixel rows by the data signals of FIGS. 13A and 13B.

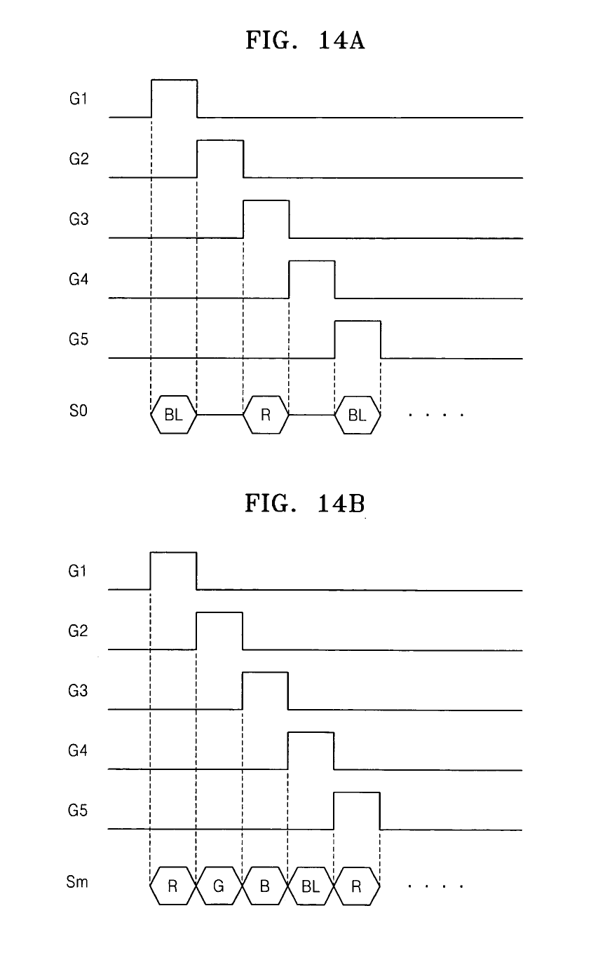

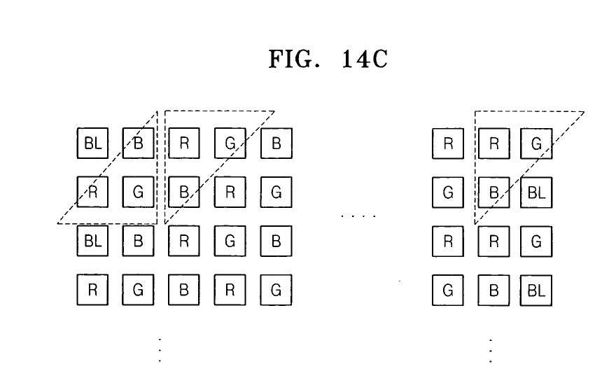

FIGS. 14A through 14C illustrate first delta driving of the panel 101A of FIG. 11.

In the first delta driving, when data is to be displayed in the image mode, black data signals BL are applied to the dummy pixels of the dummy pixel column at the leftmost side connected to every other gate line starting from the first gate line from among the odd-numbered gate lines, that is, the first, fifth, ninth gate lines GL1, GL5, GL9, . . . , and black data signals BL are applied to the sub-pixels of the sub-pixel column at the rightmost side connected to every other gate line starting from the fourth gate line from among the even-numbered gate lines, that is, the fourth, eighth, twelfth gate lines GL4, GL8, GL12, . . . .

The gate-on-signals from the gate driver 201 are sequentially applied from the first gate line GL1 to the n^{th} gate line GLn. In FIGS. 14A and 14B, the first through fifth gate-on-signals G1 through G5 are exemplarily illustrated and are sequentially applied to the first through fifth gate lines GL1 through GL5.

Referring to FIG. 14A, the dummy data signal S0 is applied from the source driver 301 to the dummy source line SL0. The source driver 301 applies black data signals BL when the gate-on-signals G1, G5, G9, . . . are applied to the odd-numbered gate lines GL1, GL5, GL9, . . . , and applies pixel data signals at the time when the gate-on-signals G3, G7, G11, . . . are applied to the odd-numbered gate lines GL3, GL7, GL11 . . . . Also, the source driver 301 applies blank data signals when the even-numbered gate-on-signals G2, G4, . . . are applied to the even-numbered gate lines GL2, GL4, . . . .

Accordingly, the source driver 301 sequentially outputs black BL and red R data signals to the dummy source line SL0 as the dummy data signal S0 with blank spaces interposed between the black BL and red R data signals.

Although not illustrated, the source driver 301 applies pixel data signals to the first through m−1^{th} source lines SL1 through SLm−1 as the first through m−1^{th} data signals S1 through Sm−1 when the odd-numbered gate-on-signals G1, G3, G5, . . . and the even-numbered gate-on-signals G2, G4, . . . are applied to the odd-numbered gate lines GL1, GL3, GL5, . . . and the even-numbered gate lines GL2, GL4, . . . , respectively.

Referring to FIG. 14B, the m^{th} data signal Sm is applied to the m^{th} source line SLm from the source driver 301. The source driver 301 applies pixel data signals when the odd-numbered gate-on-signals G1, G3, G5, . . . are applied to the odd-numbered gate lines GL1, GL3, GL5, . . . , and applies pixel data signals when the gate-on-signals G2, G6, G10, . . . are applied to the even-numbered gate lines GL2, GL6, GL10, . . . . Also, the source driver 301 applies black data signals BL when the gate-on-signals G4, G8, G12, . . . are applied to the even-numbered gate lines GL4, GL8, GL12, . . . .

Accordingly, the source driver 301 sequentially outputs red R, green G, blue B, and black BL data signals to the m^{th} source line SLm as the m^{th} data signal Sm.

Referring to FIG. 14C, the panel 101A displays data by delta driving through a combination of R, G, and B sub-pixels in two rows.

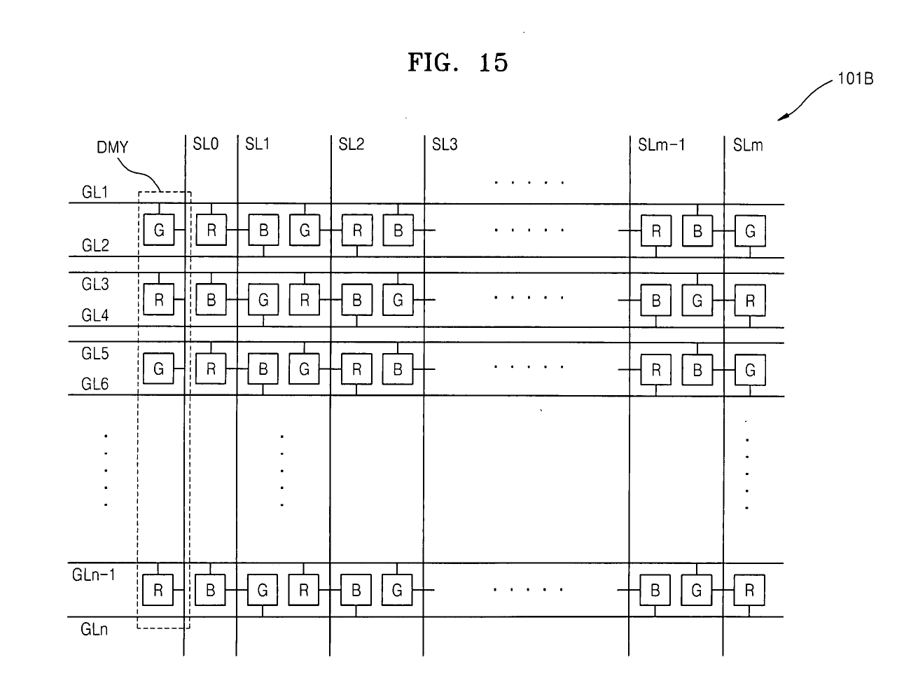

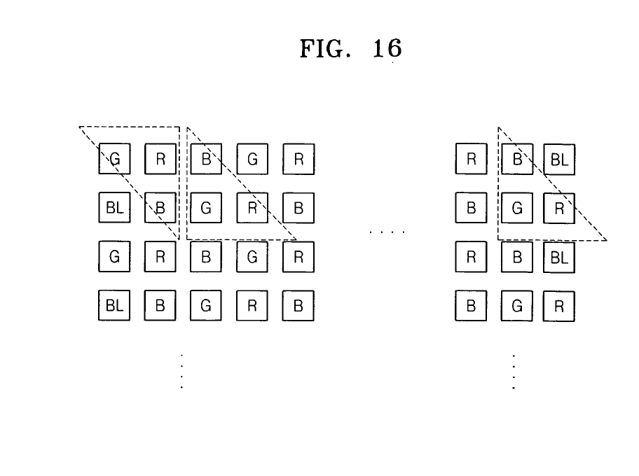

FIG. 15 illustrates a pixel structure of another panel of FIG. 11.

In a panel 101B of FIG. 15, rows where R, B, and G sub-pixels are repeated and rows where B, G, and R sub-pixels are repeated are arranged alternately arranged. However, although a sub-pixel arrangement of the panel 101B of FIG. 15 is different than that of the panel 101A of FIG. 11, other elements are the same as those of the panel 101A of FIG. 11. The panel 101B is driven by second delta driving by the sub-pixel arrangement of the panel 101B and data signals applied to each source line are described as above. Thus, detailed description thereof is omitted. As illustrated in FIG. 16, due to the second delta driving, the panel 101B displays data by delta driving through a combination of R, G, and B sub-pixels in two rows. Also, the first and second stripe driving of the panel 101B of FIG. 15 are the same as those of FIGS. 12A through 13C and thus detailed description thereof is omitted.

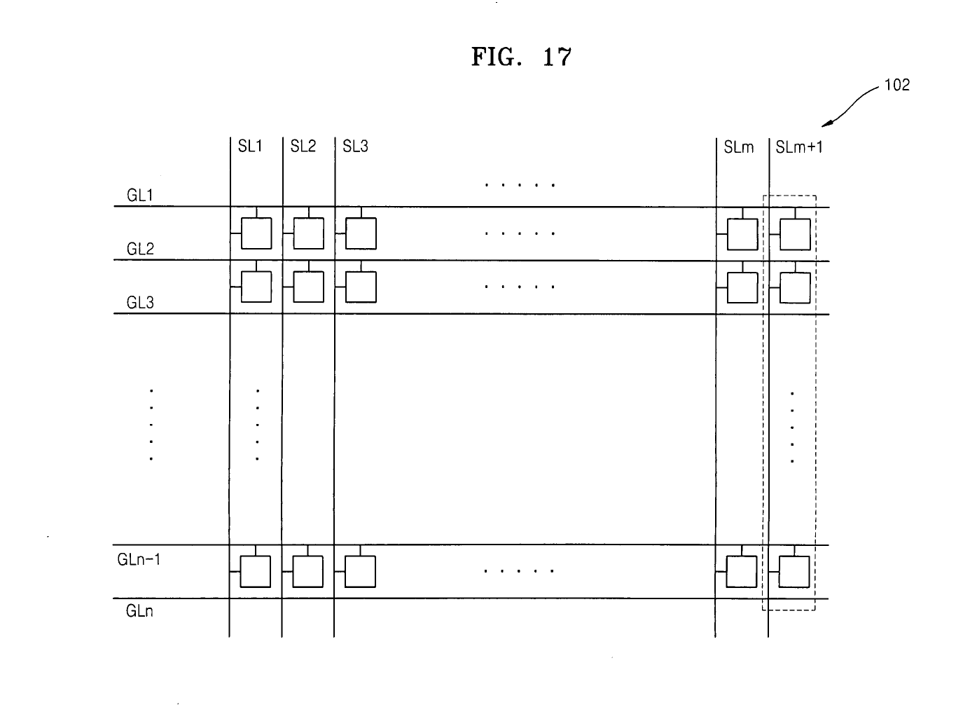

FIG. 17 illustrates a pixel structure of another panel of FIG. 1.

Referring to FIG. 17, a panel 102 includes a plurality of red R, green G, and blue B sub-pixels arranged in a stripe type arrangement in an area where the source lines SL1 through SLm+1 and the gate lines GL1 through GLn cross each other.

One sub-pixel from among R, G, and B sub-pixels in each row are connected to each of the first through m^{th} source lines SL1 through SLm.

The m+1^{th} source line SLm+1 at the rightmost side is a dummy source line, and one of the R, G, and B sub-pixels is connected as a dummy pixel to the dummy source line SLm+1.

The gate-on-signals from the first gate line GL1 to the n^{th} gate line GLn are sequentially applied to the panel 102 and switching devices of the sub-pixels are turned on by the gate-on-signals. Thus, the data signals from the first source line SL1 to the dummy source line SLm+1 are sequentially applied to the sub-pixels.

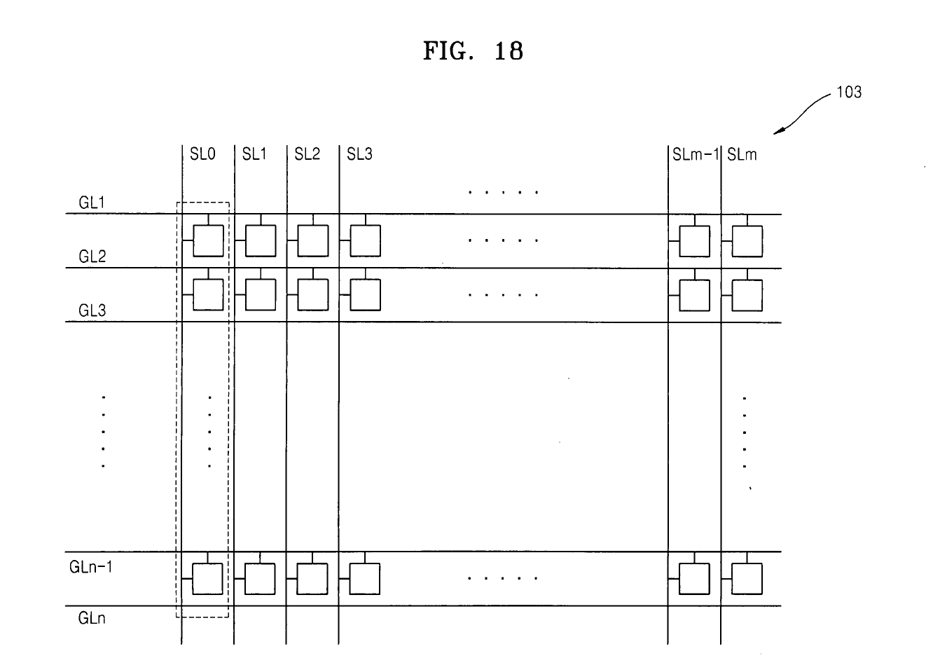

FIG. 18 illustrates a pixel structure of another panel of FIG. 10.

Referring to FIG. 18, a panel 103 includes a plurality of red R, green G, and blue B sub-pixels arranged in a stripe type arrangement in an area where the source lines SL0 through SLm and the gate lines GL1 through GLn cross each other.

One sub-pixel from among R, G, and B sub-pixels in each row are connected to the first through m^{th} source lines SL1 through SLm. The source line SL0 at the leftmost side is a dummy source line, and one of the R, G, and B sub-pixels is connected as a dummy pixel to the dummy source line SL0.

The gate-on-signals from the first gate line GL1 to the n^{th} gate line GLn are sequentially applied to the panel 103 and switching devices of the sub-pixels are turned on by the gate-on-signals. Thus, the data signals from the dummy source line SL0 to the m^{th} source line SLm are sequentially applied to the sub-pixels.

The panels 102 and 103 of FIGS. 17 and 18 are driven by stripe driving when data is to be displayed in a text mode, as illustrated in FIGS. 2A through 3B. When data is to be displayed in an image mode, the panels 102 and 103 of FIGS. 17 and 18 display data by delta driving. Driving methods are as described above and thus detailed description is omitted.

In present embodiments, stripe driving or delta driving is selectively performed according to the type of data to be displayed on a panel in stripe pixel arrangement so that vertical/horizontal line displaying and text legibility may be improved and image quality may be improved.

The display device may be applied to all display devices having a RGB pixel structure such as a liquid crystal display device and an organic light emitting display device.

According to present embodiments, dummy pixel columns are further included in a panel in a stripe pixel arrangement, and stripe driving or delta driving is selectively performed according to the type of data to be displayed so that texts and images without distortion may be displayed.

By way of summation and review, standard pixel arrangements may include a stripe type arrangement, in which rows and columns are uniformly arranged, or in a delta type arrangement, in which pixels in odd-number rows and even-number rows are arranged in zigzags, which arrangements have respective advantages and disadvantages for displaying text versus displaying images.

Embodiments are directed to a display device that may display texts and images without distortion, and a method of driving the same.

Exemplary embodiments have been disclosed herein, and although specific terms are employed, they are used and are to be interpreted in a generic and descriptive sense only and not for purpose of limitation.

What is claimed is:

1. A display device, comprising:
a mode selection unit for determining a text mode or an image mode by analyzing categories of data to be displayed; and
a panel in which a plurality of sub-pixels are arranged in a stripe type arrangement in a plurality of pixel areas defined by a plurality of gate lines and a plurality of source lines, where, among the plurality of source lines, a source line at one of a leftmost side or a rightmost side is regarded as a dummy source line, where a sub-pixel column at one of the leftmost side or the rightmost side of a plurality of sub-pixel columns is connected to the dummy source line as a dummy pixel column, the panel displaying the data in a stripe type arrangement or a delta type arrangement by partially turning off the sub-pixels of the sub-pixel columns at the leftmost side and the rightmost side according to a mode selection result.

2. The display device as claimed in claim 1, wherein two sub-pixel columns of the plurality of sub-pixel columns are connected to each of the source lines other than the dummy source line.

3. The display device as claimed in claim 2, wherein:
the dummy source line includes sub-pixels, each sub-pixel of the dummy source line being connected to odd-numbered gate lines, and
sub-pixel columns connected to the odd-numbered gate lines and sub-pixel columns connected to even-numbered gate lines are disposed at left and right sides of the source lines other than the dummy source line.

4. The display device as claimed in claim 1, wherein one sub-pixel column of the plurality of sub-pixel columns is connected to each of the plurality of source lines.

5. The display device as claimed in claim 1, wherein the panel displays the data in the stripe type arrangement in the text mode and displays the data in the delta type arrangement in the image mode.

6. The display device as claimed in claim 1, wherein the panel displays the data in the stripe type arrangement by displaying black data to the sub-pixel column at the leftmost side or the sub-pixel column at the rightmost side.

7. The display device as claimed in claim 1, wherein the panel displays the data in the delta type arrangement by alternately displaying black data signals to the sub-pixels of the sub-pixel column at the leftmost side and the sub-pixels of the sub-pixel column at the rightmost side.

8. The display device as claimed in claim 1, further comprising:
a timing controller for outputting a gate control signal and a data control signal used to control turning off of sub-pixels according to the mode selection result;
a source driver for applying black data to sub-pixels to be turned off according to the data control signal; and
a gate driver for outputting a gate signal according to the gate control signal.

9. A method of driving a display device, the method comprising:
determining a text mode or an image mode by analyzing categories of data to be displayed
outputting a gate control signal and a data control signal according to the mode selection result; and
displaying the data in a stripe type arrangement or a delta type arrangement by partially turning off a plurality of sub-pixels of a plurality of sub-pixel columns at a leftmost side and a rightmost side of a panel, in which the sub-pixels are arranged in a stripe type arrangement, according to the gate control signal and the data control signal.

10. The method as claimed in claim 9, wherein the panel displays the data in the stripe type arrangement in the text mode and displays the data in the delta type arrangement in the image mode

11. The method as claimed in claim 9, wherein the panel displays the data in the stripe type arrangement by displaying black data to a sub-pixel column at the rightmost side.

12. The method as claimed in claim 9, wherein the panel displays the data in the stripe type arrangement by displaying black data to a sub-pixel column at the leftmost side.

13. The method as claimed in claim 9, wherein the panel displays the data in the delta type arrangement by alternately displaying black data to the sub-pixels of the sub-pixel column at the leftmost side and the sub-pixels of the sub-pixel column at the rightmost side.

14. The method as claimed in claim 13, wherein the panel displays the data in the delta type by alternately displaying black data to odd-numbered sub-pixels of the sub-pixel column at the rightmost side and even-numbered sub-pixels of the sub-pixel column at the leftmost side.

15. The method as claimed in claim 13, wherein the panel displays the data in the delta type by alternately displaying black data to even-numbered sub-pixels of the sub-pixel column at the rightmost side and odd-numbered sub-pixels of the sub-pixel column at the leftmost side.

16. The method as claimed in claim 9, wherein determining of a text mode or an image mode includes determining the image mode when text and an image coexist in the data to be displayed.

17. The method as claimed in claim 9, wherein the panel includes a plurality of gate lines and a plurality of source lines, where a source line at the leftmost side or the rightmost side is regarded as a dummy source line, where a sub-pixel column at the one of the leftmost side or the rightmost side is connected to the dummy source line as a dummy pixel column.

18. The method as claimed in claim 17, wherein two sub-pixel columns of the plurality of sub-pixel columns are connected to each of the source lines other than the dummy source line.

19. The method as claimed in claim 17, wherein:
the dummy source line includes sub-pixels, each sub-pixel of the dummy source line being connected to odd-numbered gate lines, and
sub-pixel columns connected to the odd-numbered gate lines and sub-pixel columns connected to even-numbered gate lines are disposed at left and right sides of the source lines other than the dummy source line.

20. The method as claimed in claim 17, wherein one sub-pixel column of the plurality of sub-pixel columns is connected to each of the plurality of source lines.
